(19) United States
(12) Patent Application Publication
(10) Pub. No.: US 2007/0298967 A1
(43) Pub. Date: Dec. 27, 2007

(54) Compositions for Inhibiting Plant Growth and Methods and Systems for Using the Same

(75) Inventor: Kevin Kelley, Weaverville, NC (US)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: THE UNIVERSITY OF NORTH CAROLINA AT CHARLOTTE, Charlotte, NC (US)

(21) Appl. No.: 11/768,355

(22) Filed: Jun. 26, 2007

Related U.S. Application Data
(60) Provisional application No. 60/816,373, filed on Jun. 26, 2006.

(51) Int. Cl. A01N 25/00

(52) U.S. Cl. 504/116.1

(57) ABSTRACT

Compositions for inhibiting the growth of plants without substantially harming the plant can include a colorant for reducing the amount of light available to a plant for photosynthesis and an agent to assist penetration of the colorant into the plant. Alternative compositions can include other active agents useful for inhibiting the growth of plants, including agents for interrupting photosynthesis of the plant; agents for effecting stomatal closure of plants; agents for inhibiting transpiration of plants; and agents for altering hormonal pathways of plants.

### CROSS REFERENCE TO RELATED APPLICATIONS

This application hereby claims the benefit of commonly owned pending U.S. Provisional Patent Application Ser. No. 60/816,373, for Plant Growth Inhibitor, filed Jun. 26, 2006. This application incorporates entirely by reference this provisional application.

### BACKGROUND OF THE INVENTION

The present invention relates to compositions for inhibiting the growth of plants, as well as methods and systems for using the same.

Various grasses are widely used in commercial and residential landscaping, including residential lawns, sport fields, playgrounds, parks, golf courses, roadsides and cemeteries. Lawns and other grassy areas may require regular maintenance so as to provide a desired aesthetic appearance. Regular mowing can, for example, enhance the appearance of lawns by promoting more uniform grass heights, suppressing unsightly seed head development, and the like.

Regular maintenance may also improve the safety of grassy areas, for example, by clearing areas near power lines and railroad tracks, improving sight lines along roadways, and the like.

It can also be useful to control the growth of undesired vegetation, e.g., weeds, for aesthetic appearances and safety reasons.

It can be time consuming and expensive to maintain grass found in these and other locations by mowing. This can be particularly so for lawns and other areas during rapid plant growth periods, which can require more frequent mowing.

Chemical growth retarding treatments have been developed for grass and other plant maintenance, dating to the late 1940s with the development of maleic hydrazine. While useful, many chemical treatments can result in undesirable discoloration and thinning, and thus may be largely restricted to roadside and hazardous-to-mow areas. Yet even in these applications, there may be concerns regarding the cost of such treatments as well as concerns regarding handling of and exposure to these chemicals.

### BRIEF SUMMARY OF THE INVENTION

The present invention includes compositions capable of inhibiting the growth of plants, including grasses used in residential and commercial lawns, without substantially harming the plant. Inhibiting the growth rate of plants such as grassy lawns can reduce the amount of time and resources required for maintenance (including mowing). Yet, although the present invention can reduce the growth rate of vegetation, the invention may have minimal negative effect on the health and appearance of the plants. Further, the compositions can include active agents that are environmentally friendly and safe for human and/or animal contact.

The compositions of the invention include an active agent that is capable of interacting with the plant in a manner sufficient to inhibit or slow the growth rate thereof without causing significant harm to the plant. In exemplary embodiments of the invention, the compositions can include an active agent capable of “light starvation.” In these embodiments, the active agent can be a colorant capable of reducing the amount of light available to a plant for photosynthesis.

Colorants useful in the present invention can include dyes, pigments and combinations thereof, including those approved by the Federal Drug Administration (FDA). Useful dyes include food coloring dyes, and suitable sources of pigments include crayons. For various applications of the invention such as lawn care, the colorant can be a green colorant, or a combination of colorants selected to impart a green color to the composition.

In alternative embodiments of the invention, the active agent can be selected for its ability to inhibit plant growth via other mechanisms. Other useful active agents in accordance with the present invention can include agents capable of interrupting and/or inhibiting photosynthesis; agents capable of effecting stomatal closure; agents capable of transpiration inhibition; and agents capable of altering hormonal pathways of plants.

The compositions of the invention can further include an agent or a combination of agents capable of assisting penetration of the active agent colorant through a waxy substance or coating found on many plants (the cuticle) and into the plant. Exemplary plant penetration assisting agents can include natural and/or synthetic (man-made) oils, such as vegetable oils, animal oils, mineral oils, and the like, and combinations thereof. Particularly useful plant penetration assisting agents can include paraffinic oils and vegetable derived oils.

The compositions of the invention can further include a surfactant (or emulsifier) or a combination of surfactants to assist in solubilizing or dispersing the colorant into a form suitable for application to a plant. The compositions of the invention may also optionally include a colorant solvent, which can dilute the colorant, assist in solubilizing or dispersing the colorant in the plant penetrating assisting agent, and/or improve cuticle penetration. In exemplary embodiments of the invention, the colorant solvent can also be an oil, including plant derived oils, such as soybean oils and methyl esters or epoxidized oils of the same. Alternative colorant solvents can include alcohols.

The compositions of the invention can further optionally include an agriculturally acceptable carrier, such as water. The carrier can facilitate application of the active agent to the location to be treated, and can also facilitate storage, transport or handling of the composition.

The present invention can also include methods for inhibiting the growth rate of a plant without substantially harming the plant. In exemplary embodiments of the invention, the method can include treating a plant with a colorant to reduce the amount of light available to a plant for photosynthesis in an amount effective to inhibit growth of the plant without substantially harming the plant. Alternative embodiments of the invention can include treating the plant with an active agent selected for its ability to inhibit plant growth via other mechanisms, such as agents capable of interrupting and/or inhibiting photosynthesis; agents capable of effecting stomatal closure; agents capable of transpiration inhibition; and agents capable of altering hormonal pathways of plants.

The present invention can also include a system for applying an agricultural composition to plants. The application system of the invention can include a supply tank for holding a supply of the composition to be applied to a plant. The system can further include a sprayer assembly, which can include a tubular member with a plurality of spray nozzles along the length thereof, a downwardly directed spray shield covering the tubular member for directing flow of spray from the nozzles in a generally downward direction, and optionally wheels rotatably mounted to the spray shield. A supply line fluidly connects the supply tank and the sprayer assembly and directs the flow of the composition from the supply tank to the sprayer assembly. The system can further include an attachment assembly which can have at least one attachment arm with opposing ends. At least one of the opposing arm ends can be adapted for attachment to landscaping equipment, such as a lawn mower, and the other of the opposing arm ends can be adapted for attachment to the sprayer assembly. In this manner, the attachment arm can connect the sprayer assembly to landscaping equipment.

The foregoing, as well as other objectives and advantages of the invention and the manner in which the same are accomplished, are further discussed within the following detailed description and its accompanying drawings.

### BRIEF DESCRIPTION OF THE DRAWINGS

Having thus described the invention in general terms, reference will now be made to the accompanying drawings, which are not necessarily drawn to scale, and in which:

FIG. 1 is a side view of a representative agricultural composition application system useful for applying an agricultural composition to plant life attached to a lawn mower;

FIG. 2 is a partial rear perspective view of the application system of FIG. 1;

FIG. 3 is cross sectional view of the application system of FIG. 1 taken along line 3-3;

FIG. 4 is side view of a component of the application system of FIG. 1;

FIG. 5 is an enlarged partial side view of a section of the component of FIG. 4 illustrating an exemplary fastener in accordance with one embodiment of the invention;

FIG. 6 is an enlarged partial side view of a section of the component of FIG. 4 illustrating an alternative fastener in accordance with another embodiment of the invention;

FIG. 7 is a perspective front view of another representative agricultural composition application system useful for applying an agricultural composition to plant life attached to a weed trimmer;

FIG. 8 is a side view of an alternative embodiment of the agricultural composition application system for attachment to a weed trimmer;

FIG. 9 is a graph illustrating differential growth rates of fescue grass treated with a control composition and an exemplary growth inhibiting composition of the present invention; and

FIG. 10 is a graph illustrating differential growth rates of fescue grass treated with a control composition and another exemplary growth inhibiting composition of the present invention.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present invention includes compositions capable of inhibiting the growth of plants, including terrestrial plants used in residential and commercial lawns and landscaping. Examples of the types of plants that can treated in accordance with invention include grasses, trees, bushes, flowering plants, and the like. The present invention can be particularly useful in inhibiting or slowing the growth rate of grasses, such as but not limited to fescue, Bermuda, Kentucky blue grass, rye, centipede grass, Saint Augustine grass, Kikuyu grass, zoysia grass, ornamental grasses, and the like. The invention, however, is not limited to the types of plants noted herein, and accordingly the invention can also be useful for inhibiting or slowing the growth of other types of plants, including undesirable plants such as weeds, including grassy weeds such as crabgrass, annual bluegrass, dallis grass, and the like, and broad leaf weeds, such as dandelions, dock, curly dock, spurge, ground ivy, chickweed, plantain, and the like, as well as clover.

As used herein, the term inhibiting the growth of plants refers to slowing the rate of growth of the plant without significant harm to the plant (for example, as exemplified by the absence of significant phytotoxic effects on the plant), as compared to the growth rate of the same plant not treated in accordance with the invention. Inhibiting or slowing the growth rate of plants, including plants used in landscaping such as grassy lawns, can reduce the amount of time and resources required for maintenance (including mowing). Yet, although the present invention can reduce the growth rate of vegetation, the invention may have minimal negative effect on the health of the plants, the appearance of the plants, and the like.

The present invention includes compositions having an active agent as a component thereof, which active agent is capable of interacting with the plant in a manner sufficient to inhibit or slow the growth rate thereof yet without causing significant harm to the plant. In exemplary embodiments of the invention, the compositions can include an active agent capable of “light starvation.” In these embodiments, the active agent can reduce the amount of light received by a plant having a wavelength at which photosynthesis of the plant takes place so as to reduce the amount of energy that is available for biosynthesis. The active agent can, for example, absorb light or block light having a wavelength of about 400 to about 500 nanometers (nm), about 600 to about 700 nanometers (nm), or both.

Exemplary active agents useful for absorbing or blocking at least a portion of light at a wavelength at which photosynthesis takes place include colorants (also referred to herein as color additives), such as dyes, pigments, and the like, as well as combinations thereof. Advantageously, the colorant is environmentally friendly and safe for human and/or animal contact.

Colorants useful in the present invention can include those approved by the Federal Drug Administration (FDA), including colorants certified by the FDA in the following categories: Food, Drug and Cosmetic (FD&C) for color additives with applications in foods, drugs or cosmetics; Drug and Cosmetic (D&C) for color additives with applications in drugs or cosmetics; and External Drug and Cosmetic (External D&C) for color additives with applications in externally applied drugs (e.g. ointments) and in externally applied cosmetics.

In various embodiments of the invention, the colorant can be a dye, which can absorb light. Dyes useful in the invention can be organic or inorganic, and further can be natural or synthetic (man-made). Dyes can be used in any suitable form, including powders, granules, liquids, and like. Dyes are typically water soluble, although, as used herein, reference to dyes can also include water insoluble forms, referred to in the art as “lakes.” As will be appreciated by the skilled artisan, the term “lakes” generally refers to the reaction product of a water soluble dye with a metallic salt.

Dyes useful in the present invention can include without limitation natural and artificial food coloring dyes. Exemplary natural food coloring dyes include without limitation chlorella (a green dye derived from algae), annatto extract(a reddish-orange dye made from the seed of a tropical tree), B-apo-8′-carotenal, beta-carotene, beet powder, canthaxanthin, caramel color, carrot oil, cochineal extract (carmine, a red dye derived from cochineal insects), cottonseed flour, ferrous gluconate, fruit juice, grape color extract, grape skin extract (enocianina), paprika, paprika oleoresin, riboflavin, saffron, turmeric, turmeric oleoresin, vegetable juice, and the like, as well as colorants derived from minerals, such as titanium dioxide, and combinations thereof.

Exemplary artificial food coloring dyes include without limitation FD&C Blue No.1 (Brilliant Blue FCF), FD&C Blue No.2 (Indigotine), FD&C Green No.3 (Fast Green FCF), FD&C Red No.40 (Allura Red AC), FD&C Red No.3 (Erythrosine), FD&C Yellow No.5 (Tartrazine), and FD&C Yellow No.6 (Sunset Yellow FCF), as well as combinations thereof. Particularly advantageous in landscaping applications, such as lawn care, are green food coloring dyes, and/or combinations of food coloring dyes that result in a green color (such as a combination of a yellow and blue dye).

In various other embodiments of the invention, the colorant can be a pigment, which can block light. Pigments useful in the invention can also be organic or inorganic and further can be natural or synthetic. As will be appreciated by the skilled artisan, in contrast to dyes, pigments typically have little or no solubility in water.

Exemplary pigments useful in the present invention can include without limitation any of the types of pigments useful in artistic fields (such as painting). Particularly advantageous in landscaping applications, such as lawn care, are green pigments and/or combinations of pigments that result in a green color (such as a combination of a yellow and blue pigment). In various embodiments of the invention, crayons (which typically are made of a paraffin wax mixed with a suitable pigment) may be a particularly useful source of a green pigment or a combination of colors to give a desired green color, in view of the ready availability of crayons and government regulation of the safety of crayons.

In alternative embodiments of the invention, the active agent can be selected for its ability to inhibit plant growth via other mechanisms. Non-limiting examples of other useful active agents in accordance with the present invention can include agents capable of interrupting and/or inhibiting photosynthesis; agents capable of effecting stomatal closure; agents capable of transpiration inhibition; and agents capable of altering hormonal pathways of plants.

For ease of discussion, reference is generally made herein to colorants as the active agent capable of inhibiting plant growth in accordance with the various embodiments of the invention. The present invention, however, is not limited to colorant active agents, and accordingly the discussions herein with reference to application methods, formulations, concentrations of the respective components, including the active agent, and the like, can also be applicable to the other active agents described herein.

Exemplary active agents capable of interrupting and/or inhibiting photosynthesis of plants can include without limitation urea types compounds such as diuron (3-(3,4-dichlororphenyl)-1,1-dimethylurea or DCMU), linuron, isoproturon, chlorotoluron, metobenzuron, tebuthiuron, and fluometuron; triazine type compounds such as simazine, atrazine, cyanazine, terbutylazine, atraton, hexazinone, metribuzin, simetyn, ametryn, prometryn, dimethametryn, and triaziflam; uracil type compounds such as bromacil, terbacil and lenacil; anilide type compounds such as propanil and cypromid; carbamate type compounds such as desmedipham and phenmedipham; hydroxybenzonitrile type compounds such as bromoxynil, and ioxynil; and others such as pyridate, bentazon and methazole; and the like, and derivatives or analogues and combinations thereof. Exemplary embodiments of the invention can employ diuron and/or derivatives or analogues thereof, as known in the art. Exemplary diuron analogues useful in this embodiment of the invention can include without limitation diuron derivatives lacking one or both chlorine atoms. Diuron generally acts to displace loosely bound quinine in photosystem II when applied in low concentrations. Various diuron derivatives such as diuron analogues lacking one or both chlorine atoms can bind more reversibly than diuron. Such compounds can be formulated and applied to plants to inhibit the growth thereof in the manner and amounts as described herein.

Exemplary active agents capable of effecting stomatal closure can include without limitation abscisic acid and derivatives or analogues thereof. Abscisic acid and its derivatives are known in the art and are commercially available. Such compounds can be formulated and applied to plants to inhibit the growth thereof in the manner and amounts as described herein.

Exemplary active agents capable of effecting transpiration inhibition of plants can include without limitation various film forming anti-transpirants such as polyterpene polymers, vinyl acetate/vinylpyrrolidone copolymers, and the like, and combinations thereof. These and other useful film forming polymeric materials useful in agricultural applications are commercially available, for example, Agrimer® VA vinyl acetate/vinylpyrrolidone copolymers commercially available from ISP and Wilt-Pruf® beta-pinene polymers derived from the resin of pine trees commercially available from Wilt-Pruf Products, Inc. of Essex, Conn. These compounds can also be formulated and applied to plants to inhibit the growth thereof in the manner and amounts as described herein.

Exemplary active agents capable of altering hormonal pathways of plants can include without limitation direct inhibitors, such as dormins, such as abscisic acid and xanthoxin; alkenes such as ethylene and propylene; and the like, and derivatives and combinations thereof. Other exemplary active agents capable of altering hormonal pathways of plants can include without limitation growth hormone blocking agents, such as gibberellins; auxins such as indole-3-acetic acid, 2,4-dichlorophenoxyacetic acid (2,4-D), centrophenoxine, p-chlorophenoxyacetic acid, chlorogenic acid, trans-cinnamic acid, indole-3-acetic acid methyl ester, indole-3-acetyl-L-alanine, indole-3-acetyl-L-aspartic acid, indole-3-acetyl-L-phenylalanine, indole-3-acetylglycine, indole-3-butyric acid, indole-3-butyryl-p-alanine, indole-3-propionic acid, alpha-naphthaleneacetic acid, beta-naphthoxyacetic acid, phenylacetic acid, picloram, 2,4,5-tricholorophenoxyacetic acid, and 2,3,5-triiodobenzoic acid; cytokinins such as zeatin, benzyladenine, adenine, adenine hemisulfate, 6-benzylaminopurine, 6-benzylaminopurine riboside, N-benzyl-9-(2-tetrahydropyranyl)adenine, N-(2-chloro-4-pyridyl-N[prime]-phenylurea, DL-dihydrozeatin, 6-(gamma,gamma-dimethylallylamino)purine, 6-(gamma,gamma-dimethylallylamino)purine riboside, 1,3-diphenylurea, kinetin, kinetin riboside, 1-phenyl-3-(1,2,3-thiadiazol-5-yl)urea, trans-zeatin O-beta-D-glucopyranoside, and zeatin riboside; brassinosteroids; and the like, and derivatives thereof for blocking normal sites of interaction, as well as combinations of these agents. Such compounds and derivatives thereof are also known in the art and are commercially available. These compounds can be formulated and applied to plants to inhibit the growth thereof in the manner and amounts as described herein.

As will be appreciated by the skilled artisan, many types of plants include a waxy substance or coating (the cuticle). Accordingly, colorants useful in the invention can have a functionality selected to improve or aid the passage of the colorant through the cuticle and into the plant. The colorant functionality may also improve or aid the solubility or dispersibility thereof. As a non-limiting example, various dyes and/or pigments may be modified, for example via an alkylation process, to include a lipophilic functionality. Various processes useful for functionalizing a colorant will be appreciated by the skilled artisan and such colorants can be readily prepared using known techniques, and/or are readily commercially available. Accordingly, as used herein, reference to various colorants, including dyes and pigments, also includes derivatives thereof having a desired functionality to improve plant cuticle penetration, solubility, dispersibility, and the like.

The compositions of the invention can further include an agent capable of assisting penetration of the active agent colorant through the cuticle and into the plant(also referred to herein as a plant penetration assisting agent or a penetrant). The plant cuticle penetrating assisting agent may also assist in solubilizing or dispersing the colorant into a form suitable for application to a plant.

Exemplary plant penetration assisting agents can include natural and/or synthetic (man-made) oils, such as but not limited to vegetable oils, animal oils, mineral oils, such as petroleum and petroleum derived oils, and the like, and combinations thereof. Particularly useful oils can include paraffinic oils and vegetable derived oils, such as oils derived from soybeans, corn, coconut, olive, cottonseed, safflower, linseed, canola, sunflower, peanut, palm, castor, and the like, as well as methyl esters of the same and of the carboxylic acids on which these oils are based. Exemplary commercially available methyl ester vegetable oils can include the SoyGold® family of soy and canola based oils, as discussed in more detail below. The present invention is not limited to the use of oil based plant penetration assisting agents, and other agent suitable for assisting the penetration of the active agent into the plant to the treated can also be useful such as but not limited to surfactants as discussed in more detail below.

The compositions of the present invention may optionally include a surfactant (emulsifier), which can also assist in solubilizing or dispersing the colorant into a form suitable for application to a plant. As will be appreciated by the skilled artisan, surfactants can be generally described as organic compounds that are amphiphilic, meaning that they can contain both lipophilic and hydrophilic groups. Accordingly such compounds can be soluble in non-polar and polar solvents, such as organic solvents and water. Surfactants suitable for use in the present invention can be nonionic, anionic, cationic or zwitterionic. Combinations of surfactants may also be used. Particularly useful surfactants include those approved by government regulatory authorities as suitable for use in agricultural applications.

Exemplary agricultural anionic surfactants that can be useful in the present invention can include without limitation alkali metal, alkaline earth metal, and ammonium salts of alkyl- and alkylaryl sulfonates, phosphate esters, and the like, and combinations thereof. Exemplary agricultural nonionic surfactants that can be useful in the present invention can include without limitation block copolymers, alcohol ethers, alkoylated animal and vegetable fats and oils, fatty acid alkoxylates, sugar surfactants such as sorbitol and sorbitan ester alkoxylates, alkylphenol ethers, alkoylated alkylphenol resins, and the like, and combinations thereof. Blends of anionic and nonionic surfactants can also be useful in the invention. These and other suitable surfactants, as well as blends thereof, are commercially available, for example, as the Sponto family of emulsifiers from AkzoNobel, such as Sponto 300T, characterized as a lipophilic emulsifier, Sponto 500T, characterized as a hydrophilic emulsifier, and the like, and combinations thereof.

The compositions of the invention may optionally include a colorant solvent, which can dilute the colorant, assist in solubilizing or dispersing the colorant, and/or improve cuticle penetration. The colorant solvent can be a non-polar solvent or a polar solvent, depending on the type of colorant and/or surfactant used and the functionality of the same. The amount of solvent used can also vary, depending on factors such as the desired concentration of colorant in the composition.

In exemplary embodiments of the invention, the colorant solvent can be an oil, which can be the same or different from an oil type plant penetration assisting agent (for example, in exemplary embodiments the plant penetrating assisting agent and the colorant solvent can be the same agent functioning as both a penterant and solvent). Oils useful in the invention as a colorant solvent also can include natural or synthetic (man-made) oils. Exemplary oils useful in the invention can include without limitation vegetable oils, animal oils, mineral oils, such as petroleum and petroleum derived oils, and the like, and combinations thereof. Vegetable derived oils can be particularly useful, and include oils derived from soybeans, corn, coconut, olive, cottonseed, safflower, linseed, canola, sunflower, peanut, palm, castor, and the like, as well as methyl esters of the same and of the carboxylic acids on which these oils are based.

Non-limiting examples of oils useful in the invention include the SoyGold® family of soy and canola based oils, which are modified to include methyl ester functionality. The SoyGold® family of products can also be useful because they are bio-based, biodegradable, non-toxic, low VOC/high performing solvents with environmental benefits. These and other solvents can also improve cuticle penetration and thus can also assist in the delivery of the colorant into the plant. The compositions of the invention can also include combinations of these and other solvents.

The present invention is not limited to oil solvents, and other types of colorant solvents can also be useful, depending at least in part on the nature and functionality of the colorant and/or the plant penetrating assisting agent, and the like. For example, for compositions including water soluble colorants, polar solvents such as water; alcohols and glycols as well as their ethers and esters, such as methanol, ethanol, propanol, butanol, isopropanol, cyclohexanol, ethylene glycol mono- and dimethyl ether; amine, amide and lactone based solvents; and the like, may be useful, alone or in combination with other polar or non-polar solvents. Other suitable colorant solvents include without limitation aliphatic, cyclic and aromatic hydrocarbons, such as cyclohexane, paraffins, tetrahydronaphthalene, alkylated naphthalenes and their derivatives, and alkylated benzenes and their derivatives; phthalic acid esters, such as dibutyl or dioctyl phthalate; ketones such as cyclohexenone; and the like, and combinations thereof.

The compositions of the invention can further optionally include an agriculturally acceptable carrier. The carrier can be any material with which the active agent is formulated to facilitate application to the location to be treated, which may for example be the plant or the area surrounding the plant, or to facilitate storage, transport or handling. A carrier may be a solid or a liquid, including material which is normally a gas but which has been compressed to form a liquid.

Exemplary liquid carriers, which may be the same or different from the colorant solvent as discussed herein, useful in the invention can include without limitation water; vegetable oils; animal oils; mineral oils; aliphatic, cyclic and aromatic hydrocarbons, such as cyclohexane, paraffins, tetrahydronaphthalene, alkylated naphthalenes and their derivatives, and alkylated benzenes and their derivatives; phthalic acid esters, such as dibutyl or dioctyl phthalate; alcohols and glycols as well as their ethers and esters, such as methanol, ethanol, propanol, butanol, isopropanol, cyclohexanol, ethylene glycol mono- and dimethyl ether; ketones such as cyclohexenone; strongly polar solvents, for examples amines such as N-methyl pyrrolidone, N-octylpyrrolidone and N-cyclohexylpyrrolidone, or lactones such as gamma-butyrolactone; epoxidized plant oil esters such as methylated coconut or soybean oil ester, and the like, and combinations thereof.

Exemplary solid carriers useful in the invention can include without limitation mineral earths such as silicas, silica gels, silicates, talc, kaolin, limestone, lime, chalk, bole, loess, clay, dolomite, diatomaceous earth, calcium sulfate, magnesium sulfate, magnesium oxide, sand, ground synthetic materials, fertilizers such as ammonium sulfate, ammonium phosphate, ammonium nitrate, ureas, and products of vegetable origin such as cereal meal, tree bark meal, wood meal and nutshell meal, cellulose powders, and the like, and combinations thereof.

The compositions according to the invention can be formulated in any of the known forms useful in agricultural applications. The compositions can be formulated, for example, in the form of ready-to-spray aqueous solutions, powders and suspensions or in the form of highly concentrated aqueous, oily or other suspensions, dispersions, emulsions, oil dispersions, pastes, dusts, materials for broadcasting or granules, and the like, and the compositions can be applied using conventional techniques, such as spraying, atomizing, dusting, broadcasting, watering, pouring, and the like. The skilled artisan will appreciate that concentrated forms of the composition can be diluted by the user before application.

The compositions can be formulated using any well established processes as known in the art. These procedures can generally include mixing and/or milling of the active agent with the other ingredients as discussed herein, including surfactant, colorant solvent, and carrier, and optionally fillers, solid and/or liquid auxiliaries and/or adjuvants such as wetters, dispersants, penetrants, stickers, humectants, emulsifiers, thickeners, extenders, defoamers, preservatives, stabilizers, and the like, as well as additional solvents and/or surfactants. Typically, the formulations can be prepared so as to ensure as fine and uniform as possible a distribution of the active agent.

The compositions can be supplied as concentrates including a high proportion of the active agent (for example colorant), wherein the concentrate is to be diluted before use, for example, with water to form an aqueous dispersion or emulsion. These concentrates typically can withstand storage for prolonged periods and after storage can be capable of dilution with for example water to form an aqueous preparation with sufficient homogeneity to enable their application with conventional spray equipment. The proportion of the active agent (for example colorant as described herein) in the concentrate can vary and can generally range from about 0.5 to about 95% by weight, as another example from about 0.5 to about 50% by weight, and as another example from about 1 to about 35% by weight, based on the total weight of the concentrate. The proportion of the plant penetration assisting agent (such as a paraffinic oil or vegetable oil) as described herein can also vary and generally can range from about 1 to about 50% by weight, and as another example from about 5 to about 30% by weight, and as another example, from about 10 to about 30% by weight, based on the total weight of the concentrate. In various embodiments of the invention, the total weight percent of the active agent (for example colorant) can also be described in terms of the total weight percent of both the active agent and the plant penetration assisting agent, in which embodiments the total weight percent of the active agent/plant penetration assisting agent can range from about 5 to about 35 weight percent, based on the total weight of the concentrate. The proportion of the surfactant described herein in the concentrate can also vary and generally can range from about 1 to about 30% by weight, and as another example, from about 1 to about 15% by weight, based on the total weight of the concentrate. The present invention, however, is not limited to these ranges of components in a concentrate form, and accordingly the components can be used in amounts less than or greater than the ranges noted herein.

The concentrate form of the composition can further include a suitable carrier as described herein. The proportion of carrier, such as water, in the concentrate can also vary, and can generally range from about 10 to about 75% by weight, for example, from about 30 to about 65% by weight, based on the total weight of the concentrate. The concentrates can further include other ingredients, including a suitable colorant solvent (which can in various embodiments be the same or different as the penetrant) as described herein in an amount ranging from about 0 to about 80% by weight, based on the total weight of the concentrate. The present invention, however, is not limited to these ranges of components in a concentrate form, and accordingly the components can be used in amounts less than or greater than the ranges noted herein.

The present invention further includes methods for inhibiting the growth of plants without significantly harming the plant (as exemplified, for example, by the absence of significant phytotoxic effects on the plant and/or undesirable effects on the appearance of the plant). The method of the invention includes applying a growth inhibiting effective amount of the active agent to a plant and/or to an area surrounding the plant in a manner selected to allow the active agent to inhibit growth of the plant via one of the mechanisms as described herein, but without substantially harming the plant. The method can further include applying the active agent in combination with the plant penetration assisting agent in an amount sufficient to assist penetration of the active agent (for example colorant) through the cuticle and into the plant.

Application can be to any part of the plant, such as the foliage, stems, branches or roots, or a combination thereof. For example, when using a colorant capable of absorbing light used in photosynthesis of a plant, the growth rate of plants (such as grasses found in residential and commercial lawns and landscaping) can be inhibited by applying the active agent to those portions of the plant involved in photosynthesis, e.g., the foliage.

Generally, as noted herein, the composition may be supplied in concentrate form whereas the end user generally employs diluted compositions. The factor of dilution can vary (for example but not limited to ⅕, 1/10, 1/20, and 1/30 dilution factors) and the concentration of the active agent in the diluted composition may vary depending upon factors such as the type of active agent used, the other components present in the composition, the types of plants to be treated, the desired degree of plant growth inhibition, and the like, so long as the active agent is present in a growth inhibiting (yet substantially non-harmful) amount. As a non-limiting example, the compositions may generally be diluted to provide a composition having a concentration of 0.001% to about 10% of the active agent (for example, colorant). The present invention, however, is not limited to these and accordingly the active agent can be used in amounts less than or greater than the ranges noted herein.

The diluted compositions may further include the plant penetration assisting agent in an amount sufficient to assist penetration of the active agent (such as colorant) through the cuticle and into the plant. The skilled artisan will appreciate that the relative amount of plant penetration assisting agent present in the diluted solution can be readily determined based the amount of plant penetration assisting agent in the concentrate and the dilution factor employed to achieve the desired concentration of active agent. As a non-limiting example, the compositions may generally be diluted to provide a composition having a concentration of plant penetration assisting agent in an amount of about 0.5 to about 20%. The present invention, however, is not limited to these ranges, and accordingly the plant penetration assisting agent can be used in amounts less than or greater than the ranges noted herein.

Similarly, the skilled artisan will appreciate that the relative amount of other components of the composition, such as surfactant or emulsifier, colorant solvent, carrier, and the like, when present, in the diluted solution can be readily determined based on the amount of component in the concentrate and the dilution factor employed to achieve the desired concentration of active agent, and can be readily determined by the skilled artisan based on the teachings herein. As an example, generally the surfactant concentration can be about 1/10^{th} that of the active agent, for example, from about 0.001 to about 1% of the final composition weight. Again, however, the present invention is not limited to these ranges, and accordingly the surfactant, when present, can be used in amounts less than or greater than the ranges noted herein.

The application rates of the composition can vary, again depending on factors such as the type and concentration of the active agent (colorant) used, the type and amounts of other components present in the composition, the identity of the plant to be treated, and desired degree of growth inhibition, and can range from about 0.005 to 5 kilograms per hectare (kg/ha), for example, from about 0.08 to 3 kg/ha. Stated in another way, the application rate of the active agent (such as colorant) may be in the range of 0.1 to 500 grams of active agent (g a.a.) per hectare, with rates between 2 to 100 g a.a./ha often achieving satisfactory growth inhibition. The present invention is not so limited, and the desired application rate (of the composition and/or active agent) may be readily determined by established tests known to those skilled in the art. Accordingly, application rates outside of these ranges may also be useful.

Advantageously the compositions of the invention are formulated as spray mixtures, as discussed herein. The spray mixtures can be applied in a manner know per se. The skilled worker is familiar with the equipment and techniques furthermore required for doing this.

The present invention can further include an unique agricultural composition application system, which can be useful for applying a plant growth inhibiting composition to plant life. The present invention is discussed herein in terms of applying a plant growth inhibiting composition, but this aspect of the invention is not limited to this particular use and can be applicable for application of any type of plant treatment, such as but not limited the application of herbicides, insecticides, fertilizers, and the like.

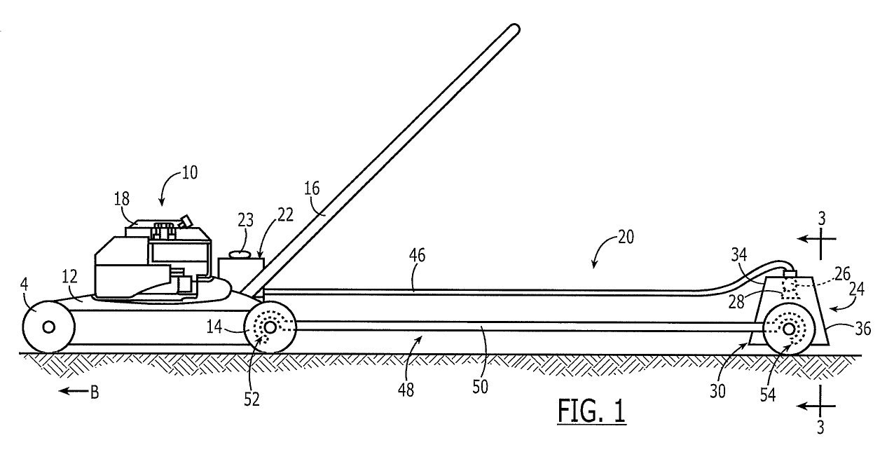

FIG. 1 is a side view of a push lawn mower 10 having attached thereto a representative agricultural composition application system 20 in accordance with the invention. For ease of discussion, FIG. 1 illustrates the combination of application system 20 and a lawn mower. The present invention is not so limited, however, and application system 20 can also be used in combination with other types of landscaping and/or maintenance equipment (referred to herein generally as landscaping equipment), such as fertilizer spreaders, weed trimmers or edgers (also referred to in the art as weed eaters), hedge trimmers, pruners, and the like.

Lawn mower 10 can be any type of lawn mower known in the art, and the operation and structure thereof will not be described in detail herein. Generally, lawn mower 10 can include a housing 12 movable by wheels 14 on the ground in the direction of arrow B. The lawn mower can be directed by an operator pushing a handle bar 16. The lawn mower can further include an engine 18 for driving the mower and rotatable cutting blades (not illustrated) mounted underneath the housing 12 of the mower.

Application system 20 can include a supply tank 22 for holding a supply of the composition to be applied to plants, such as a lawn. Supply tank 22 can be any suitable size and shape as appropriate for a particular use in combination with a particular type of landscaping equipment (lawn mower, weed trimmer, etc.), which the skilled artisan will appreciate and understand based on the disclosures herein without undue experimentation. As an example, supply tank 22 may hold one, two, five or more gallons of the agricultural composition when used in combination with a mower as illustrated in FIG. 1, yet may have less capacity when used in combination with a weed trimmer or edger. Supply tank 22 further can be made of any suitable material appropriate for use with a given agricultural composition, including various polymeric materials as known in the art.

Supply tank 22 can be mounted to an upper surface of housing 12 of the push mower using any conventional mounting techniques and devices suitable for securing a tank to a lawn mower platform, which the skilled artisan will appreciate and understand are suitable for use in the present invention based on the disclosures herein without undue experimentation. Supply tank 22 can alternatively be mounted to another part of the landscaping equipment, such as handle bar 16 (for example, by hanging the supply tank from the handle bar) or other parts of the equipment as suitable for a particular type of equipment. Another alternative is for the operator of the landscaping equipment to carry the tank. An agricultural composition, such as a plant growth inhibiting composition as described herein, can be introduced into the supply tank 22 via an opening generally located in an upper region thereof, and the opening can be closed using a suitable cap, such as a screw cap 23.

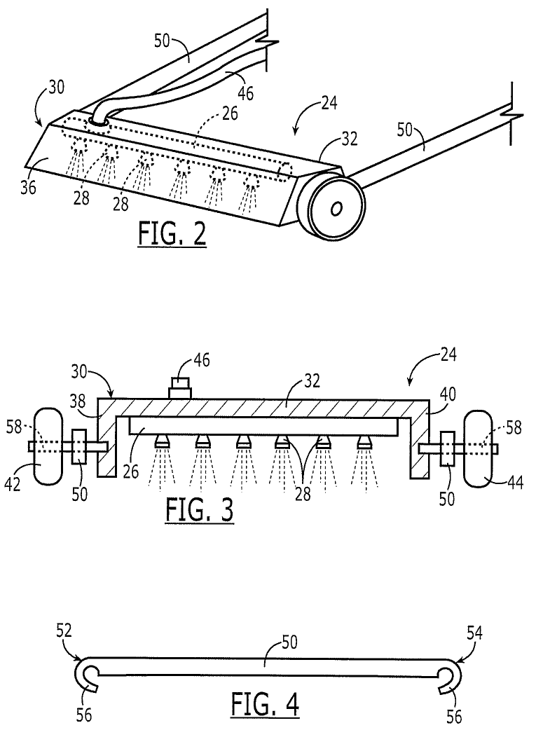

Application system 20 can further include a sprayer assembly designated generally at 24 in FIG. 1. Reference is made to FIGS. 2 and 3, which illustrate a rear perspective view and a cross-sectional view taken along line 3-3 of FIG. 1, respectively, of sprayer assembly 24. As illustrated in FIGS. 2 and 3, sprayer assembly 24 can include a tubular member 26, which can be substantially flexible or rigid, with a plurality of spray nozzles 28 along the length of thereof. Tubular member 26 can be oriented substantially perpendicular to the direction of movement of the lawn mover, as illustrated.

Sprayer assembly 24 can further include a downwardly directed spray shield 30 including a top wall 32, opposing front and rear walls 34,36 and opposing end walls 38,40. Spray shield 30 is generally open along the lower portion thereof and is positioned to cover tubular member 26. The walls of the spray shield act to direct flow of spray emitted from the nozzles 28 in a generally downward direction, as illustrated.

The various components of the sprayer assembly can be made of any suitable material useful in the manufacture of landscaping equipment, including metals and polymeric materials as known in the art.

Tubular member 26 can be mounted directly onto an upper inner surface of a top wall 32 using techniques and devices as known in the art. Alternatively, tubular member 26 can be suspended within shield 30 using techniques and devices also as known in the art. Again, the skilled artisan will appreciate and understand the types of mounting or fastening devices and techniques suitable for use in the present invention, based on the disclosures herein without undue experimentation.

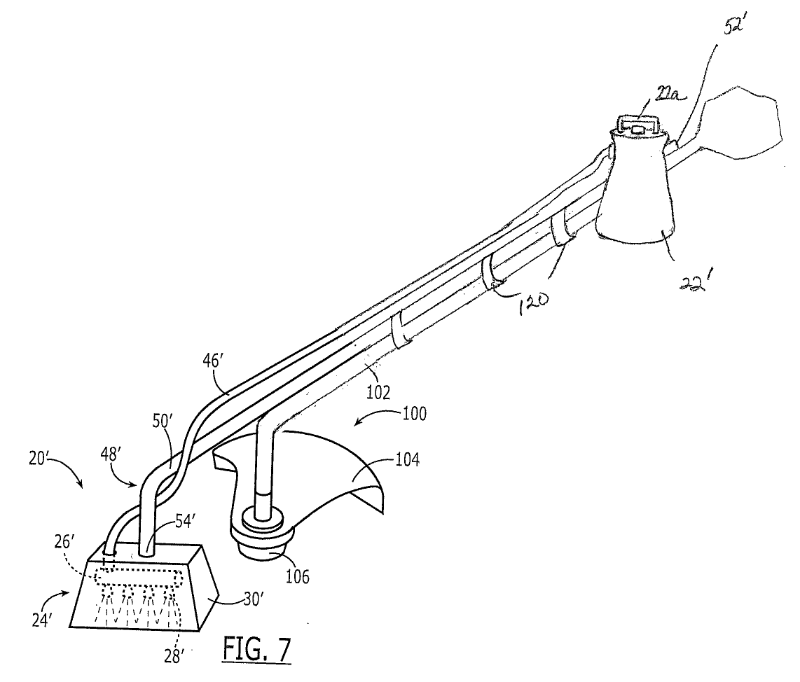

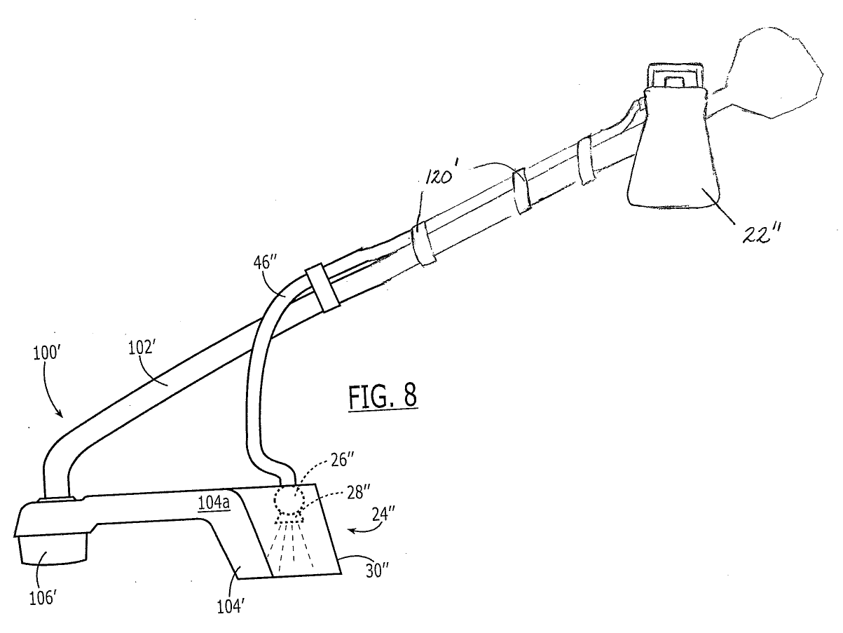

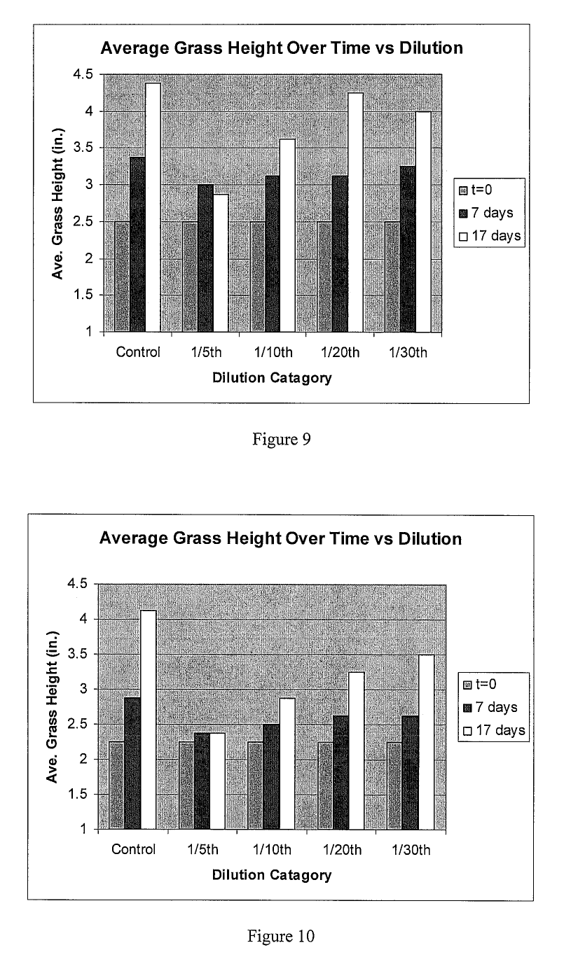

When used in combination with landscaping equipment that is pushed or driven along the ground, such as a lawn mower as illustrated, spray shield 30 can be moveably supported above the ground surface by pair of wheels 42,44, which can be rotatably mounted to opposing end walls 38,40, respectively. Wheels 42,44, however, are optional and may not be required when the application system is used in combination with other types of equipment that are not pushed along the ground, such as hand held weed trimmers, spreaders, hedge trimmers, and the like, such as weed trimmers 100 and 100′ schematically illustrated in FIGS. 7 and 8 (discussed in more detail below).

Application system 20 can further include a supply line 46 fluidly connecting supply tank 22 and tubular member 26 of the spray assembly. Supply line 46 directs the flow of fluid from supply tank 22 to spray assembly 24 and into tubular member 26. Supply line 46 can also be made of any suitable material appropriate for use with a given agricultural composition, including various polymeric materials as known in the art, and can be in the form of, for example, a polymeric (plastic) flexible tubing.

Fluid exits tubular member 26 through nozzles 28, which direct the spray in generally downward direction. The supply tank 22 of the system can optionally be pressurized using any suitable means such as a compressor, pump and the like, to provide positive pressure to pump fluid from supply tank 24 through supply line 46 into tubular member 26 to exit nozzles 28.

Application system 20 can further include an attachment or coupling assembly 48 for attaching or coupling sprayer assembly 24 to landscaping equipment, such as lawn mower 10. As illustrated, when used in combination with landscaping equipment that is pushed or driven along the ground, advantageously sprayer assembly 24 is a rear mounted system. However, sprayer assembly 24 may in alternative embodiments be attached along a front or other portions of the landscaping equipment, such as hand held weed trimmer or edger 100 or 100′ as schematically illustrated in FIGS. 7 and 8. For embodiments in which the application system is used in combination with equipment that is pushed or driven along the ground, attachment assembly 48 can attach the sprayer system to a rear portion of the lawn mower (or other equipment) so that the sprayer assembly 24 trails an operator using the equipment (for example, trails an operator pushing the mower). In this way, the operator can avoid stepping on or otherwise contacting fluid sprayed onto the ground via nozzles 28.

Attachment assembly 48 can include at least one arm 50 having opposing ends 52,54, and can include two arms 50 aligned substantially parallel to one another. The length of arms 50 can be selected to provide sufficient space between mower 10 and sprayer assembly 24 for the operator to walk and avoid contact with fluid sprayed by the nozzles onto the ground as noted above. Stated differently, the arms can have a length corresponding to or slightly longer than the average stride length of a person. The attachment assembly components can also be made of any suitable material useful in the manufacture of landscaping equipment, including metals and polymeric materials as known in the art.

At least one end 52 of arm 50 is adapted for attachment to lawn mower 10 (or other equipment such as trimmer 100). End 52 of arm 50 can be releasably attached to mower 10 so that the sprayer assembly can be detached from the mower as desired. Alternatively, end 52 of arm 50 can be an integral part of the mower (or other equipment) to provide a system dedicated to application of fluids to a lawn using the mower. Advantageously, opposing end 54 of arm 50 is also adapted for releasable attachment to sprayer assembly 24, although in alternative embodiments, end 54 can be an integral part of the sprayer assembly 24 (such as end 54′ illustrated with trimmer 100 of FIG. 7).

An exemplary releasable attachment mechanism is illustrated in FIGS. 1 and 4 as a hook-shaped portion 56 of each of opposing ends 52,54, adapted to fit onto a rod shaped member, such as an axle associated with the rear wheels of lawn mower 10, and an axle or pin 58 securing wheels 42,44 to spray shield 30.

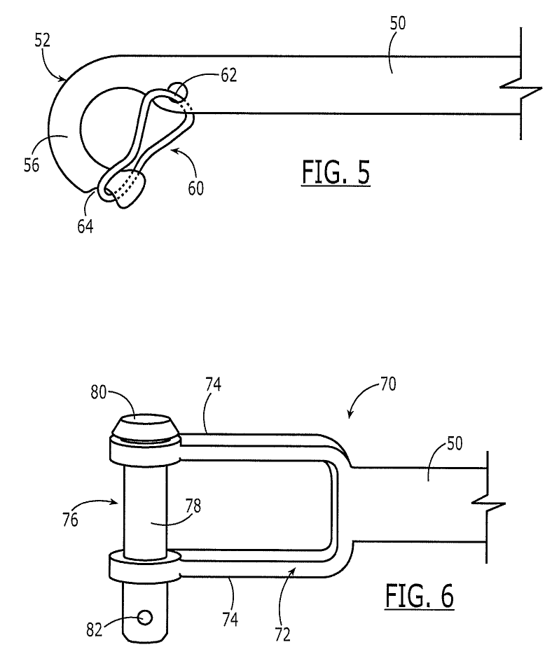

When present, hook shaped portion 56 can be secured to an axle using any suitable fastener, such as illustrated in FIGS. 5 and 6. FIG. 5 is an enlarged view of an end 52 of arm 50 and illustrates one embodiment of a fastener useful in the invention. As illustrated in FIG. 5, hook-shaped portion 56 can be fastened to an axle using a spring clip 60 as known in the art. In the embodiment illustrated in FIG. 5, at least one end 52 (and typically both ends 52,54) of arm 50 can include an opening 62 located at a region of the arm 50 adjacent the hook shaped portion 56, through which one end of clip 60 can be inserted, and a notch 64 proximate an end of hook shaped portion 56, in which an opposing end of spring clip 60 can rest.

FIG. 6 is an enlarged view of alternative structure of end 52 of arm 50 and illustrates schematically another embodiment of a suitable fastener useful in the invention. As illustrated in FIG. 6, end 52 (and typically both ends 52,54) of arm 50 can include a clevis assembly as known in the art, designated generally at 70. Clevis assembly 70 can include a shackle 72 including substantially parallel arms 74 generally forming a C shape, wherein each of the arms includes an opening located at an end portion thereof. Clevis assembly 70 further includes a clevis pin 76 having a shank 78 with a head 80 at one end thereof and an opening 82 located at an opposing end of shank 78. As will be appreciated by the skilled artisan, clevis assembly 70 can secure arm 50 to an axle using a suitable cotter pin (not shown) inserted into opening 82, also as known in the art.

In this manner, the ends of each arm 50 can be releasably attached to the lawn mower, and optionally to the sprayer assembly, so that the sprayer assembly can be readily detached from the lawn mower (or other equipment) as desired. The present invention is not limited to the attachment mechanism illustrated, and accordingly other attachment or coupling mechanisms can also be used.

The present invention is also not limited to the shape of arm 50 as illustrated in FIG. 4, and alternative shapes of arm 50 are also contemplated. As another non-limiting example, FIG. 7 illustrates an application system 20′ useful with hand held equipment such as a conventional weed trimmer 100 having a shaft 102 attached in a conventional manner to a shroud 104 at one end thereof for covering a weed trimmer mechanism 106 to protect the user. Weed trimmers including a shaft, shroud, and weed trimmer mechanism are well known in the art and are commercially available. Accordingly, the particulars of the structure and operation of the weed trimmer, including the weed trimmer mechanism, are not described in detail herein.

The alternative application system 20′ illustrated in FIG. 7 can include a supply tank for holding a supply of a composition to be applied to a lawn or other plants (such as tank 22′ having a handle 22a, which can be hand held as illustrated or attached to an upper region of the trimmer); and a sprayer assembly 24′ including a tubular member 26′ with a plurality of spray nozzles 28′ along the length thereof and a downwardly directed spray shield 30′ covering the tubular member for directing flow of spray from the nozzles in a generally downward direction. Application system 20′ can further include a supply line 46′ fluidly connecting the supply tank and the sprayer assembly for directing the flow of the composition from the supply tank to the sprayer assembly. As noted herein, the supply tank can be any suitable size and shape as appropriate for a particular use in combination with a particular type of landscaping equipment, such as weed trimmer 100, and the skilled artisan will appreciate and understand the same based on the disclosures herein without undue experimentation.

Application system 20′ can further include an attachment assembly 48′ for attaching the sprayer assembly to the trimmer 100. In this embodiment of the invention, attachment assembly 48′ can include at least one arm 50′ having opposing ends 52′,54′, wherein at least one of the opposing arm ends 54′ is attached to the sprayer assembly (such as to an outer surface of the top wall thereof using conventional and well known attachment mechanisms and techniques). As illustrated in FIG. 7, in this embodiment, arm 50′ may be differently shaped than arm 50 of FIGS. 1-4, and may be for example curved along at least a portion near end 54′ attached to the sprayer assembly 24′ so as to follow the shape of the equipment to which the sprayer is attached. In an alternative embodiment, arm 50′ and supply line 46′ can be integrated as a single component to both attach the sprayer assembly to the equipment and supply the fluid to the sprayer assembly. In these alternative embodiments, sprayer assembly 24′ can be fastened to the weed trimmer 100 using any suitable fastener, for example, a series of clamps such as pipe clamps 120 to fasten at least a portion of arm 50′ and/or supply line 46′ (singly or as an integrated component) to shaft 102 of weed trimmer 100.

FIG. 8 illustrates a side view of yet another embodiment of an application system of the invention. A weed trimmer 100′ includes a shaft 102′, a shroud 104′ and a weed trimmer mechanism 106′. In this embodiment of the invention, shroud 104′ and a sprayer assembly 24″ including a tubular member 26″ with a plurality of spray nozzles 28″ along the length thereof and a downwardly directed spray shield 30″ covering the tubular member for directing flow of spray from the nozzles in a generally downward direction as described herein are integrated.

In this embodiment, the sprayer assembly 24″ and shroud 104′ can be joined together to form an integrated device or component using conventional techniques and devices for attaching or securing metal or polymeric components to one another to form an unitary or single component, such as but not limited to welding, fasteners (nuts and bolts, screws, rivets, clips, etc.), and the like, as well as combinations thereof. Alternatively, an integrated shroud/sprayer assembly can be produced using various molding or other manufacturing techniques. Regardless of the manufacturing technique employed, both a front or leading wall 104a of shroud 104′ and a rear wall of spray shield 30″ can be present, or alternatively either of the wall 104a or rear wall of spray shield 30″ can be absent.

The integrated shroud/sprayer assembly can be provided as a replacement for a standard shroud of a conventional weed trimmer, such as shroud 104 of weed trimmer 100 of FIG. 7. The integrated shroud/sprayer assembly can be attached to a shaft 102′ using any suitable attachment mechanism as known in the art for attaching a shroud to a weed trimmer, such as one or more standard wing nut clamps and further can be shaped and sized as appropriate for use with a particular weed trimmer.

Also in this embodiment of the invention, the application system can further include a supply tank for holding a supply of a composition to be applied to a lawn such as tank 22″, which can be hand held as illustrated or attached to an upper region of the trimmer. The application system of this embodiment can further include a supply line 46″ fluidly connecting supply tank 22″ and the sprayer assembly of the integrated shroud/sprayer assembly for directing the flow of the composition from the supply tank to the sprayer assembly. The supply line 46″ can be attached to shaft 102′ using any suitable fastener, such as a series of clamps, such as pipe clamps 120′. As noted herein, the supply tank can be any suitable size and shape as appropriate for a particular use in combination with a particular type of landscaping equipment, such as weed trimmer 100′, and the skilled artisan will appreciate and understand the same based on the disclosures herein without undue experimentation.

The present invention will be further illustrated by the following non-limiting examples.

### EXAMPLE 1

A sample emulsion concentrate in accordance with an exemplary embodiment of the invention is prepared using green food coloring as the active ingredient. The sample stock emulsifiable concentrate solution is prepared from 7 mL of the active ingredient (in this case, green food coloring), 0.5 mL of Sponto 300T and 0.7 mL of Sponto 500T as emulsifiers (each commercially available from Akzo Nobel), 4 mL of vegetable oil (as the plant penetration assisting agent), and 9.2 mL of water. This emulsifiable concentrate is then diluted ⅕, 1/10, 1/20, and 1/30 with water. The various dilutions are sprayed onto different sections of an experimental lawn consisting of tall fescus directly after cutting. Another section of the experimental lawn is also treated with a control sample including vegetable oil, emulsifiers, and water in the same concentration as the ⅕ dilution.

The lawn is watered every two days for 17 days. FIG. 6 is a graph illustrating grass height of each of the treated sections of the lawn prior to application of the compositions (t=0) and as measured at seven days and seventeen days after application of the compositions. As illustrated, the composition of the invention exhibits grass growth inhibiting properties as compared to the control composition. In addition, the 1/10th dilution of the sample composition in accordance with the present invention proved superior in the trial with the lawn remaining healthy while exhibiting 0.75 in less growth than the lawn treated with the control sample without food coloring.

### EXAMPLE 2

Another sample emulsion concentrate in accordance with another exemplary embodiment of the invention is prepared using an oil based dye system (a green dye dissolved in SoyGold, as available from Sunbelt Corp., Rock Hill, S.C.) as the active ingredient. This sample stock emulsifiable concentrate solution is prepared from 6 mL of the active ingredient, 2 mL of Sponto 300T and 0.4 mL of Sponto 500T as emulsifiers(each commercially available from Akzo Nobel), and 13.2 mL of water. This emulsifiable concentrate is then diluted ⅕, 1/10, 1/20, and 1/30 with water. The various dilutions are sprayed onto different sections of an experimental lawn consisting of tall fescus directly after cutting. Another section of the experimental lawn is also treated with a control sample having the same composition as the control sample of Example 1.

The lawn is watered every two days for 17 days. FIG. 7 is a graph illustrating grass height of each of the treated sections of the lawn prior to application of the compositions (t=0) and as measured at seven days and seventeen days after application of the compositions. As illustrated, the composition of the invention exhibits grass growth inhibiting properties as compared to the control composition.

In the specification and examples, there have been disclosed typical embodiments of the invention and, although specific terms have been employed, they have been used in a generic and descriptive sense only and not for purposes of limitation, the scope of the invention being set forth in the following claims.

That which is claimed is:

1. A composition for inhibiting the growth of plants, comprising:
a colorant for reducing the amount of light available to a plant for photosynthesis in an amount effective to inhibit growth of the plant without substantially harming the plant; and
a plant penetration assisting agent.

2. The composition of claim 1, wherein said colorant comprises a FDA approved colorant.

3. The composition of claim 1, wherein said colorant reduces the amount of light available to a plant having a wavelength of about 400 to about 500 nanometers (nm), a wavelength of about 600 to about 700 nanometers (nm), or both.

4. The composition of claim 1, wherein said colorant comprises a colorant selected from dyes, pigments, and combinations thereof.

5. The composition of claim 4, wherein said colorant comprises a dye.

6. The composition of claim 5, wherein said dye comprises food coloring.

7. The composition of claim 6, wherein said food coloring comprises green food coloring or a combination of food coloring sufficient to impart a green color to the composition.

8. The composition of claim 4, wherein said colorant comprises a pigment.

9. The composition of claim 8, wherein said pigment comprises a green pigment or a combination of pigments sufficient to impart a green color to the composition.

10. The composition of claim 9, wherein said pigment is derived from a crayon.

11. The composition of claim 1, wherein said plant penetration assisting agent comprises an oil in an amount sufficient to assist penetration of the colorant into the plant.

12. The composition of claim 11, wherein said oil comprises a paraffinic oil.

13. The composition of claim 11, wherein said oil comprises a vegetable oil or a derivative thereof.

14. The composition of claim 1, further comprising a surfactant.

15. The composition of claim 14, wherein said surfactant comprises a blend of surfactants.

16. The composition of claim 1, further comprising a colorant solvent.

17. The composition of claim 16, wherein said solvent comprises a vegetable oil based solvent.

18. The composition of claim 17, wherein said vegetable oil based solvent is selected from soybean oil, derivatives of soybean oil, and combinations thereof.

19. The composition of claim 18, wherein said soybean oil derivative comprises a methyl ester functionality.

20. The composition of claim 16, wherein said solvent comprises an alcohol.

21. The composition of claim 1, further comprising a carrier.

22. The composition of claim 21, comprising an aqueous carrier.

23. A concentrate useful for inhibiting the growth of plants, comprising a colorant for reducing the amount of light available to a plant for photosynthesis and an agent to assist penetration of the colorant into the plant.

24. A composition for inhibiting the growth of plants, comprising:
green food coloring or a combination of food coloring sufficient to impart a green color to the composition in an amount effective to inhibit growth of the plant without substantially harming the plant;
an oil in an amount sufficient to assist penetration of the food coloring into the plant;
optionally a surfactant; and
optionally an aqueous carrier.

25. A composition for inhibiting the growth of plants, comprising:
green crayon or a combination of crayons sufficient to impart a green color to the composition in an amount effective to inhibit growth of the plant without substantially harming the plant;
an oil in an amount sufficient to assist penetration of the crayon into the plant;
optionally a surfactant; and
optionally an aqueous carrier.

26. A composition for inhibiting the growth of plants, comprising:
at least one or more of an agent for interrupting photosynthesis of the plant; an agent for effecting stomatal closure of the plant; an agent for inhibiting transpiration of the plant; or an agent for altering hormonal pathways of the plant, in an amount effective to inhibit growth of the plant without substantially harming the plant; and
a plant penetration assisting agent.

27. A method for inhibiting the growth rate of a plant, comprising treating a plant with a colorant to reduce the amount of light available to a plant for photosynthesis in an amount effective to inhibit growth of the plant without substantially harming the plant.

28. The method of claim 27, wherein said treating step comprises applying a composition comprising said colorant to the plant.

29. The method of claim 28, wherein said applying step comprises spraying the composition onto the foliage of the plant.

30. The method of claim 28, wherein said composition further comprises an agent to assist penetration of the colorant into the plant.

31. The method of claim 27, comprising treating a lawn with the colorant.

32. A method for inhibiting the growth rate of a plant, comprising treating the plant with an active agent in an amount effective to inhibit growth of the plant without substantially harming the plant, said active agent comprising one or more of:
an agent for interrupting photosynthesis of the plant;
an agent for effecting stomatal closure of the plant;
an agent for inhibiting transpiration of the plant; or
an agent for altering hormonal pathways of the plant.

33. A system useful for applying an agricultural composition to plants, comprising:
a supply tank for holding a supply of the composition to be applied to a plant;
a sprayer assembly comprising a tubular member with a plurality of spray nozzles along the length thereof and a downwardly directed spray shield covering the tubular member for directing flow of spray from the nozzles in a generally downward direction;
a supply line fluidly connecting the supply tank and the sprayer assembly for directing the flow of the composition from the supply tank to the sprayer assembly; and
an attachment assembly for attaching the spray assembly to landscaping equipment comprising at least one arm having opposing ends, wherein one of the opposing arm ends is attachable to landscaping equipment and the other of the opposing arm ends is attached to the sprayer assembly.

34. The system of claim 33, wherein said sprayer assembly further comprises wheels rotatably mounted to opposing ends of the spray shield.

35. The system of claim 33, wherein the arm end of the attachment assembly attachable to landscaping equipment is releasably attachable to landscaping equipment.

36. The system of claim 35, wherein the releasably attachable arm end comprises a hook shaped end portion.

37. The system of claim 33, wherein the attachment assembly comprises a pair of substantially parallel arms each comprising opposing ends, wherein one of the opposing arm ends is attachable to landscaping equipment and the other of the opposing arm ends is attached to the sprayer assembly.

38. The system of claim 33, wherein the arm of the attachment assembly comprises a curved section proximate the end attached to the spray assembly.

39. A push lawn mower and rear mounted agricultural composition application system for applying a composition to a lawn, comprising:
a push lawn mower comprising a housing movably supported by pairs of rotatable front and rear wheels;
a supply tank for holding a supply of a composition to be applied to a lawn;
a sprayer assembly comprising a tubular member with a plurality of spray nozzles along the length thereof oriented substantially perpendicular to the direction of movement of the lawn mover, a downwardly directed spray shield covering the tubular member for directing flow of spray from the nozzles in a generally downward direction, and wheels rotatably mounted at opposing end portions of the spray shield;
a supply line fluidly connecting the supply tank and the sprayer assembly for directing the flow of the composition from the supply tank to the sprayer assembly; and
an attachment assembly for attaching the sprayer assembly to the lawn mower so that the sprayer assembly trails behind the mower, wherein said attachment assembly comprises at least one arm having opposing ends, wherein one of the opposing arm ends is attached to the lawn mower and the other of the opposing arm ends is attached to the sprayer assembly.

40. The push lawn mower and rear mounted agricultural composition application system of claim 39, wherein the attachment assembly arm is sufficiently long to provide space between the mower and the sprayer assembly for an operator to walk while pushing the mower and avoid contact with fluid sprayed by the nozzles onto the ground.

41. The push lawn mower and rear mounted agricultural composition application system of claim 39, wherein the arm end attached to the lawn mower is releasably attached to the lawn mower.

42. The push lawn mower and rear mounted agricultural composition application system of claim 41, wherein the arm end releasably attached to the lawn mower comprises a hook shaped end portion.

43. The push lawn mower and rear mounted agricultural composition application system of claim 39, wherein the attachment assembly comprises a pair of substantially parallel arms, each having opposing ends, wherein one of the opposing arm ends is attached to the lawn mower and the other of the opposing arm ends is attached to the sprayer assembly.

44. The push mower and rear mounted agricultural composition application system of claim 39, further comprising an engine mounted on the housing of the lawn mower for providing a driving force for the mower and rotating grass cutting blades underlying the housing.

45. A weed trimmer and agricultural composition application system mounted thereon for applying a composition to plants, comprising:
a weed trimmer comprising a shaft with opposing ends, a weed trimming mechanism attached to one end of said shaft and a shroud covering at least a potion of said weed trimming mechanism for protecting a user;
a supply tank for holding a supply of the composition to be applied to a plant;
a sprayer assembly comprising a tubular member with a plurality of spray nozzles along the length thereof and a downwardly directed spray shield covering the tubular member for directing flow of spray from the nozzles in a generally downward direction; and
a supply line fluidly connecting the supply tank and the sprayer assembly for directing the flow of the composition from the supply tank to the sprayer assembly.

46. The weed trimmer and agricultural composition application system mounted thereon of claim 45, further comprising an attachment assembly for attaching the spray assembly to the weed trimmer.

47. The weed trimmer and agricultural composition application system mounted thereon of claim 46, wherein the attachment assembly comprises at least one arm having opposing ends, wherein at least a portion of the arm is attached to the shaft of said weed trimmer and wherein an end of the arm is attached to the sprayer assembly.

48. The weed trimmer and agricultural composition application system mounted thereon of claim 45, wherein said weed trimmer shroud and said spray shield are an integral component.
